(19) United States
(12) Patent Application Publication
(10) Pub. No.: US 2007/0069514 A1
(43) Pub. Date: Mar. 29, 2007

(54) Seat belt type R

(76) Inventors: Nicholas Anthony Regoli, Richland, WA (US); Bruno Regoli, Amelia Island, FL (US)

Correspondence Address: NICOLAS ANTHONY REGOLI, 2156 NEWHAVEN LOOP, RICHLAND, WA, 99352-7663, US

(21) Appl. No.: 11/234,811

(22) Filed: Sep. 26, 2005

(51) Int. Cl. B60R 22/00

(52) U.S. Cl. 280/801.1; 297/468

(57) ABSTRACT

The improvement provided by the Type R belt over the existing seat belt is the Light Reflective Surface. The high visibility properties of the Type R belt will enhance the rapid detection and location of seat belts by Law Enforcement and Emergency Rescue Personnel.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING

Not Applicable

### BACKGROUND OF THE INVENTION

The object of this Seat Belt Improvement is to increase the safety and survivability of motor vehicle occupants.

The Light Reflective Seat Belt Type R will enable law enforcement personnel to quickly detect vehicle occupants not using seat belts. The high visibility factor of the Type R Seat Belt will enhance the compliance with, and enforcement of, “Click It or Ticket” Seat belt laws.

The Type R Seat Belt will aid Emergency Rescue Personnel in the rapid location of seat belts during rescue operations at vehicle accidents.

### BRIEF SUMMARY OF THE INVENTION

The Seat Belt material is to have a high light reflective surface. The object of the reflective surface is to enhance the belt visibility in all ambient light conditions.

### BRIEF DESCRIPTION OF THE SEVERAL VIEWS OF THE DRAWING

Not Applicable

### DETAILED DESCRIPTION OF THE INVENTION

This improvement to the non-reflective type seat belt currently in use, is the addition of a light reflective surface to the seat belt material. This reflective surface will enhance the belt's visibility.

The addition of the reflective surface may be a step in the manufacturing process, or may be applied to the belt material after manufacture.

### DRAWINGS

Not Applicable

1. We claim that the improved visibility of the light reflective type seat belt will: Enhance the ability of Law Enforcement Personnel to detect the use or non-use of seat belts, and facilitate the visual location of seat belts by Emergency Rescue Personnel.
